(19) United States
(12) Patent Application Publication
(10) Pub. No.: US 2026/0040281 A1
(43) Pub. Date: Feb. 5, 2026

(54) METHOD AND DEVICE IN NODES USED FOR WIRELESS COMMUNICATION

(71) Applicant: APOGEE NETWORKS, LLC, DALLAS, TX (US)

(72) Inventors: Qi JIANG, Shanghai (CN); Xiaobo ZHANG, Shanghai (CN)

(73) Assignee: APOGEE NETWORKS, LLC, DALLAS, TX (US)

(21) Appl. No.: 18/733,891

(22) Filed: Jun. 5, 2024

Related U.S. Application Data
(63) Continuation of application No. PCT/CN2022/138323, filed on Dec. 12, 2022.

(30) Foreign Application Priority Data
Dec. 20, 2021 (CN) 202111563606.2

(51) Int. Cl. H04W 72/0446; H04B 7/06; H04W 72/0453; H04W 72/11

(52) U.S. Cl. CPC H04W 72/0446; H04B 7/06968; H04W 72/0453; H04W 72/11

(57) ABSTRACT

A node first receives a first signaling, the first signaling is used to determine a first time-frequency resource; and then receives or transmits a first signal in the first time-frequency resource; the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal. The present application improves the transmission method of semi-persistent transmission, so as to optimize system performance.

### CROSS REFERENCE TO RELATED APPLICATIONS

This application is the continuation of the international patent application No. PCT/CN2022/138323, filed on Dec. 12, 2022, and claims the priority benefit of Chinese Patent Application No.202111563606.2, filed on Dec. 20, 2021, the full disclosure of which is incorporated herein by reference.

### BACKGROUND

### Technical Field

The present application relates to transmission methods and devices in wireless communication systems, and in particular to a transmission scheme and device for semi-persistent scheduling or configured scheduling in wireless communications.

### Related Art

In 5G New Radio (NR), Massive Multi-Input Multi-Output (MIMO) is a key technology. In the massive MIMO, multiple antennas based on beamforming to form a relatively narrow beam which points to a particular direction to improve the quality of communication. In 5G NR, a base station can update a Transmission Configuration Indication (TCI) used by a terminal to receive a Physical Downlink Control Channel (PDCCH) and a TCI used to receive a Physical Downlink Shared Channel (PDSCH) through Medium Access Control (MAC) Control Elements (CEs) or dynamic signalings, so as to ensure the performance gains brought by beamforming. Similarly, the base station can also update QCL (Quasi Co-located) parameters adopted by multiple different types of physical-layer channels or QCL parameters on multiple carriers through a DCI (Downlink Control Information) to reduce signaling overhead.

In the discussion of NR R17, for the scenario of Multi-TRP (transmitting and receiving node), issues related to inter-cell operations are being discussed. In RAN1 #104b-e meeting, another extra Physical Cell Identity (PCI) different from a serving cell PCI is introduced.

### SUMMARY

In existing NR systems, typically, when a base station schedules a terminal via some specific RNTI (Radio Network Temporary Identifiers)-identified PDCCH, a corresponding data channel indicated by the PDCCH also adopts the specific RNTI for scrambling to resist interference. At the same time, the BTS activates or de-activates/releases a downlink SPS (Semi-Persistent Scheduling) or the uplink Type 2 CS (Configured Scheduling) through a PDCCH identified by an RNTI other than a C-RNTI (Cell Radio Network Temporary Identifier). However, in the M-TRP scenario, the base station can dynamically update a QCL relation of a PDSCH received or a PUSCH (Physical Uplink Shared Channel) transmitted by the UE through a DCI; further, there exists a scenario where an updated QCL relation switches from being associated to a serving cell PCI to being associated to a non-serving cell PCI, and thus how to deal with the SPS configuration or CS configuration needs to be reconsidered when an SPS configuration or a CS configuration spans two TCI states that have been associated to different PCIs respectively.

The present application discloses a solution to the above problem of non-dynamic scheduling in M-TRP scenarios. It should be noted that in the description of the present application, M-TRP is only used as a typical application scenario or example; the present application is also applicable to other scenarios facing similar problems, such as single TRP scenarios, or scenarios where multiple base stations collaborate together, or base stations or UEs with stronger capabilities, or for different technical fields, for example, in addition to SPS or CS, it can also be used in dynamic scheduling, channel estimation, measurement, demodulation and other fields to achieve similar technical effects. Additionally, the adoption of a unified solution for various scenarios, including but not limited to scenarios of M-TRP, contributes to the reduction of hardware complexity and costs. If no conflict is incurred, embodiments and characteristics of the embodiments in a first node in the present application are also applicable to a second node, and vice versa. Particularly, for interpretations of the terminology, nouns, functions and variants (if not specified) in the present application, refer to definitions given in Technical Specification (TS) 36 series, TS38 series and TS37 series of 3GPP specifications.

The present application provides a method in a first node for wireless communications, comprising:
receiving a first signaling, the first signaling being used to determine a first time-frequency resource; and
receiving a first signal in the first time-frequency resource;
herein, the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

The present application provides a method in a first node for wireless communications, comprising:
receiving a first signaling, the first signaling being used to determine a first time-frequency resource; and
transmitting a first signal in the first time-frequency resource;
herein, the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

In one embodiment, one feature of the above method is in: in conventional systems, an RNTI used to identify a PDCCH is often also used for scrambling of a data channel scheduled by a PDCCH, whereas whether a data channel scheduled by a PDCCH in the scheme proposed in the present application still uses RNTI scrambling identifying a PDCCH depends on a type of an RNTI identifying a PDCCH.

In one embodiment, one feature of the above method is in: being applicable to M-TRP scenarios that do not configure an RNTI other than two C-RNTIs of a same type for a UE, so as to conserve RNTI resources of the system.

According to one aspect of the present application, comprising:
receiving a first information block, the first information block being generated at a protocol layer below the RRC layer;
herein, a CORESET (Control Resource Set) where the first signaling is located is associated with a first identity; the first information block is used to determine that at least one CORESET is associated with a second identity, and the first identity is different from the second identity; the first identity and the second identity respectively identify a cell; only when the first time-frequency resource is located after a first effective time in time domain, scrambling of the first signal is related to a type of target RNTI, and an effective time of the first information block is the first effective time.

In one embodiment, one feature of the above method is in: it is indicated through a unified TCI that a reference signal changes from being associated with a serving cell PCI to being associated with a PCI other than the serving cell PCI; at the same time, the first node still maintains the transmission of SPS or CS.

In one embodiment, another feature of the above method is in: the first node is assigned an RNTI used for an SPS or a CS in a TRP or cell associated with the first identity, and the first node is not assigned an RNTI used for an SPS or a CS in a TRP or cell associated with the second identity.

According to one aspect of the present application, comprising:
receiving a second signaling;
herein, the type of the target RNTI belongs to the second type set; a type of RNTI used to identify the second signaling belongs to the first type set; an RNTI used to identify the second signaling is associated with the second identity; the second signaling is used to deactivate or release scheduling of the first signaling.

In one embodiment, one feature of the above method is in: an RNTI identifying a PDCCH used to activate an SPS or CS transmission is different from an RNTI identifying a PDCCH used to deactivate/release a same SPS or CS transmission, so as to increase flexibility of system implementation.

According to one aspect of the present application, comprising:
performing channel monitoring in K2 candidate time-frequency resources;
herein, the first node receives a first signal in the first time-frequency resource, and the first signaling is used to determine K1 candidate time-frequency resources, where K1 is a positive integer greater than 1; any one of the K2 candidate time-frequency resources is one of the K1 candidate time-frequency resources; K2 is a positive integer not greater than K1; the channel monitoring performed in the K2 candidate time-frequency resources is used to determine that scheduling indicated by the first signaling is deactivated or released.

According to one aspect of the present application, comprising:
receiving a first message;
herein, the first message is used to configure at least the target RNTI; the first message comprises a first RNTI and a second RNTI, both a type of the first RNTI and a type of the second RNTI belong to a first type set; the first RNTI and the second RNTI are respectively associated with the first identity and the second identity; the second signaling is identified by the second RNTI.

In one embodiment, one feature of the above method is in: without affecting the transmission of SPS/CS, the first node is configured with two C-RNTIs respectively used for the scheduling of two TRPs or cells, but is not configured with two CS-RNTIs (Configured Scheduling RNTIs)/SPS-RNTIs, which in turn does not add extra RNTI overhead.

According to one aspect of the present application, comprising:
transmitting a target signaling;
herein, the target signaling is used to determine that the first information block is correctly received, and a position of the first effective time in time domain is related to time-domain resources occupied by the target signaling.

According to one aspect of the present application, comprising:
receiving a second signal in a second time-frequency resource;
herein, the first signaling is used to determine multiple candidate time-frequency resources, the second time-frequency resource is one of the multiple candidate time-frequency resources, and the second time-frequency resource is different from the first time-frequency resource; the second time-frequency resource is located before the first effective time in time domain, and the first time-frequency resource is located after the first effective time in time domain; a first candidate time-frequency resource is used to determine spatial characteristics of the first signal, and a second candidate time-frequency resource is used to determine spatial characteristics of the second signal; the first candidate time-frequency resource is different from the second candidate time-frequency resource; the first information block is used to determine the first candidate time-frequency resource.

According to one aspect of the present application, comprising:
transmitting a second signal in a second time-frequency resource;
herein, the first signaling is used to determine multiple candidate time-frequency resources, the second time-frequency resource is one of the multiple candidate time-frequency resources, and the second time-frequency resource is different from the first time-frequency resource; the second time-frequency resource is located before the first effective time in time domain, and the first time-frequency resource is located after the first effective time in time domain; a first candidate time-frequency resource is used to determine spatial characteristics of the first signal, and a second candidate time-frequency resource is used to determine spatial characteristics of the second signal; the first candidate time-frequency resource is different from the second candidate time-frequency resource; the first information block is used to determine the first candidate time-frequency resource.

In one embodiment, one feature of the above method is in: when a reference signal indicated by a unified TCI changes from being associated with a serving cell PCI to being associated with a PCI other than the serving cell PCI, a reference signal indicated by a unified TCI is used to determine spatial characteristics of a data channel after a unified TCI effective time.

The present application provides a method in a second node for wireless communications, comprising:
transmitting a first signaling, the first signaling being used to determine a first time-frequency resource; and
transmitting a first signal in the first time-frequency resource;
herein, the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

The present application provides a method in a second node for wireless communications, comprising:
transmitting a first signaling, the first signaling being used to determine a first time-frequency resource; and
receiving a first signal in the first time-frequency resource;
herein, the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

According to one aspect of the present application, comprising:
transmitting a first information block, the first information block being generated at a protocol layer below the RRC layer;
herein, a CORESET where the first signaling is located is associated with a first identity; the first information block is used to determine that at least one CORESET is associated with a second identity, and the first identity is different from the second identity; the first identity and the second identity respectively identify a cell; only when the first time-frequency resource is located after a first effective time in time domain, scrambling of the first signal is related to a type of target RNTI, and an effective time of the first information block is the first effective time.

According to one aspect of the present application, comprising:
transmitting a second signaling;
herein, the type of the target RNTI belongs to the second type set; a type of RNTI used to identify the second signaling belongs to the first type set; an RNTI used to identify the second signaling is associated with the second identity; the second signaling is used to deactivate or release scheduling of the first signaling.

According to one aspect of the present application, comprising:
determining whether scheduling indicated by the first signaling is deactivated or released, and dropping transmitting scheduling associated with the first signaling in K2 candidate time-frequency resources;
herein, the second node transmits a first signal in the first time-frequency resource, and the first signaling is used to determine K1 candidate time-frequency resources, where K1 is a positive integer greater than 1; any one of the K2 candidate time-frequency resources is one of the K1 candidate time-frequency resources; K2is a positive integer not greater than K1; a receiver of the first signaling comprises a first node, and the channel monitoring performed by the first node in the K2 candidate time-frequency resources is used to determine whether scheduling indicated by the first signaling is deactivated or released.

According to one aspect of the present application, comprising:
transmitting a first message;
herein, the first message is used to configure at least the target RNTI; the first message comprises a first RNTI and a second RNTI, both a type of the first RNTI and a type of the second RNTI belong to a first type set; the first RNTI and the second RNTI are respectively associated with the first identity and the second identity; the second signaling is identified by the second RNTI.

According to one aspect of the present application, comprising:
receiving a target signaling;
herein, the target signaling is used to determine that the first information block is correctly received by a transmitter of the target signaling, and a position of the first effective time in time domain is related to time-domain resources occupied by the target signaling.

According to one aspect of the present application, comprising:
transmitting a second signal in a second time-frequency resource;
herein, the first signaling is used to determine multiple candidate time-frequency resources, the second time-frequency resource is one of the multiple candidate time-frequency resources, and the second time-frequency resource is different from the first time-frequency resource; the second time-frequency resource is located before the first effective time in time domain, and the first time-frequency resource is located after the first effective time in time domain; a first candidate time-frequency resource is used to determine spatial characteristics of the first signal, and a second candidate time-frequency resource is used to determine spatial characteristics of the second signal; the first candidate time-frequency resource is different from the second candidate time-frequency resource; the first information block is used to determine the first candidate time-frequency resource.

According to one aspect of the present application, comprising:
receiving a second signal in a second time-frequency resource;
herein, the first signaling is used to determine multiple candidate time-frequency resources, the second time-frequency resource is one of the multiple candidate time-frequency resources, and the second time-frequency resource is different from the first time-frequency resource; the second time-frequency resource is located before the first effective time in time domain, and the first time-frequency resource is located after the first effective time in time domain; a first candidate time-frequency resource is used to determine spatial characteristics of the first signal, and a second candidate time-frequency resource is used to determine spatial characteristics of the second signal; the first candidate time-frequency resource is different from the second candidate time-frequency resource; the first information block is used to determine the first candidate time-frequency resource.

The present application provides a first node for wireless communications, comprising:
a first receiver, receiving a first signaling, the first signaling being used to determine a first time-frequency resource; and
a first transceiver, receiving a first signal in the first time-frequency resource, or transmitting a first signal in the first time-frequency resource;
herein, the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

The present application provides a second node for wireless communications, comprising:
a first transmitter, transmitting a first signaling, the first signaling being used to determine a first time-frequency resource; and
a second transceiver, transmitting a first signal in the first time-frequency resource, or receiving a first signal in the first time-frequency resource;
herein, the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

In one embodiment, advantages of the scheme in the present application are: whether a data channel scheduled by a PDCCH still adopts scrambling of an RNTI identifying a PDCCH depends on a type of an RNTI that identifies a PDCCH, thereby optimizing system performance and avoiding unnecessary waste of RNTI resources.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of a first signaling according to one embodiment of the present application;

FIG. 6 illustrates a flowchart of a first signaling according to another embodiment of the present application;

FIG. 7 illustrates a flowchart of a first message according to one embodiment of the present application;

FIG. 8 illustrates a flowchart of a second signaling according to one embodiment of the present application;

FIG. 9 illustrates a flowchart of channel monitoring according to one embodiment of the present application;

FIG. 10 illustrates a flowchart of a second signal according to one embodiment of the present application;

FIG. 11 illustrates a flowchart of a second signal according to another embodiment of the present application;

FIG. 12 illustrates a schematic diagram of a timing relation according to one embodiment of the present application;

FIG. 13 illustrates a schematic diagram of an application scenario according to one embodiment of the present application;

FIG. 14 illustrates a structure block diagram of a processor in a first node according to one embodiment of the present application;

FIG. 15 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates flowchart of processing of a first node, as shown in FIG. 1. In step 100 illustrated by FIG. 1, each box represents a step. In Embodiment 1, a first node in the present application receives a first signaling in step 101, and the first signaling is used to determine a first time-frequency resource; operates a first signal in the first time-frequency resource in step 102.

In embodiment 1, the first signaling is identified by a target RNTI; whether the target RNTI is used for scrambling of the first signal is related to a type of the target RNTI; the operating action is receiving, or, the operating action is transmitting; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

In one embodiment, a physical-layer channel occupied by the first signaling comprises a PDCCH.

In one embodiment, the first signaling is a DCI.

In one embodiment, the first signaling is a PDCCH Validation.

In one embodiment, the first signaling is used to activate a Semi-Persistent Scheduling (SPS).

In one embodiment, the first signaling is used to activate a CS (configured scheduling).

In one embodiment, the first signaling is used to activate a DL SPS.

In one embodiment, the first signaling is used to activate a type 2 uplink grant.

In one embodiment, the first signaling is used to activate a type 2 configured grant scheduling on SL (Sidelink).

In one embodiment, the first signaling is used to activate a semi-persistent CSI (Channel State Information).

Typically, the first signaling is transmitted in the at least one CORESET.

Typically, a search space where the first signaling is located is associated with a CORESET in the at least one CORESET.

In one embodiment, the first signaling is used to activate a transmission corresponding to a DL (Downlink) SPS (Semi-Static Scheduling) configuration corresponding to an sps-ConfigIndex.

In one embodiment, the first signaling is used to activate a transmission corresponding to a UL (Uplink) configured grant configuration corresponding to a configuredGrantConfigIndex.

In one embodiment, the first signaling is used to activate a transmission corresponding to a UL configured Grant configuration corresponding to a configuredGrantConfigIndexMAC.

In one embodiment, the first signaling is used to activate a transmission corresponding to an SL (Sidelink) configured Grant configuration corresponding to an sl-ConfigIndexCG.

Typically, when the type of the target RNTI belongs to the second type set, the first signaling is used to determine multiple candidate time-frequency resources, and the first time-frequency resource is one of the multiple candidate time-frequency resources.

In one embodiment, the first signaling is used to indicate the multiple candidate time-frequency resources.

In one embodiment, the multiple candidate time-frequency resources belong to a DL SPS configuration corresponding to a same sps-ConfigIndex.

In one embodiment, the multiple candidate time-frequency resources belong to a UL configured Grant configuration corresponding to a same configuredGrantConfigIndex.

In one embodiment, the multiple candidate time-frequency resources belong to a UL configured Grant configuration corresponding to a same configuredGrantConfigIndexMAC.

In one embodiment, the multiple candidate time-frequency resources belong to an SL configured Grant configuration corresponding to a same sl-ConfigIndexCG.

Typically, when the type of the target RNTI belongs to the first type set, the first signaling is used to determine the first time-frequency resource.

In one embodiment, the first signaling is used for indicating the first time-frequency resource.

In one embodiment, the first time-frequency resource set occupies more than one positive integer number of REs.

In one embodiment, a physical-layer channel occupied by the first signal comprises a PDSCH.

In one embodiment, a transport channel occupied by the first signal comprises a Downlink Shared Channel (DL-SCH).

In one embodiment, a physical-layer channel occupied by the first signal comprises a PUSCH.

In one embodiment, a transport channel occupied by the first signal comprises an Uplink Shared Channel (UL-SCH).

In one embodiment, the first signal is generated by a Transport Block (TB).

In one embodiment, the first signal is a radio signal.

In one embodiment, the first signal is a baseband signal.

In one embodiment, the target RNTI is a non-negative integer.

In one embodiment, the target RNTI occupies 16 bits.

In one embodiment, the meaning that the first signaling is identified by a target RNTI comprises: a CRC (Cyclic Redundancy Check) comprised in the first signaling is scrambled through the target RNTI.

In one embodiment, the meaning that the first signaling is identified by a target RNTI comprises: the first signaling is scrambled through the target RNTI.

In one embodiment, the meaning that the first signaling is identified by a target RNTI comprises: the first signaling is generated through the target RNTI.

In one embodiment, the meaning that the first signaling is identified by a target RNTI comprises: the target RNTI is used to initialize a generator of a scrambling sequence of the first signaling.

In one embodiment, the meaning that the first signaling is identified by a target RNTI comprises: the target RNTI is used to initialize a generator of a scrambling sequence of a CRC comprised in the first signaling.

In one embodiment, the meaning that the target RNTI is used for scrambling of the first signal comprises: the target RNTI is used to initialize a generator of a scrambling sequence of the first signaling.

In one embodiment, the meaning of the type of the target RNTI comprises: the target RNTI is which type of RNTI in C-RNTI, CS-RNTI, SPS-RNTI, SP-CSI-RNTI, SL Semi-Persistent Scheduling V-RNTI, SL-CS-RNTI, SL-RNTI, SL-L-CS-RNTI, MCS-C-RNTI, TC-RNTI, SI-RNTI, P-RNTI, RA-RNTI, SFI-RNTI, TPC-PUSCH-RNTI, TPC-PUCCH-RNTI, MsgB-RNTI, INT-RNTI, SFI-RNTI, TPC-SRS-RNTI, CI-RNTI, or PS-RNTI.

In one embodiment, the first type set comprises a C-RNTI.

In one embodiment, the first type set only comprises a C-RNTI.

In one embodiment, the first type set does not comprise any of a CS-RNTI, an SPS-RNTI, or an SP-CSI-RNTI.

In one embodiment, the first type set comprises any type of RNTI other than a CS-RNTI, an SPS-RNTI, or an SP-CSI-RNTI.

Typically, the second type set comprises at least one RNTI, and a DCI identified by each of the at least one RNTI is used for scheduling an activation or scheduling a release.

Typically, the second type set comprises at least one RNTI, and a DCI identified by each of the at least one RNTI is used for scheduling an activation or scheduling a deactivation.

Typically, the second type set comprises at least a CS-RNTI.

In one embodiment, the second type set does not comprise a C-RNTI.

In one embodiment, the second type set comprises at least one of a CS-RNTI, an SPS-RNTI, or an SP-CSI-RNTI.

In one embodiment, the second type set does not comprise an RNTI used to identify a dynamically scheduled PDCCH.

### Embodiment 2

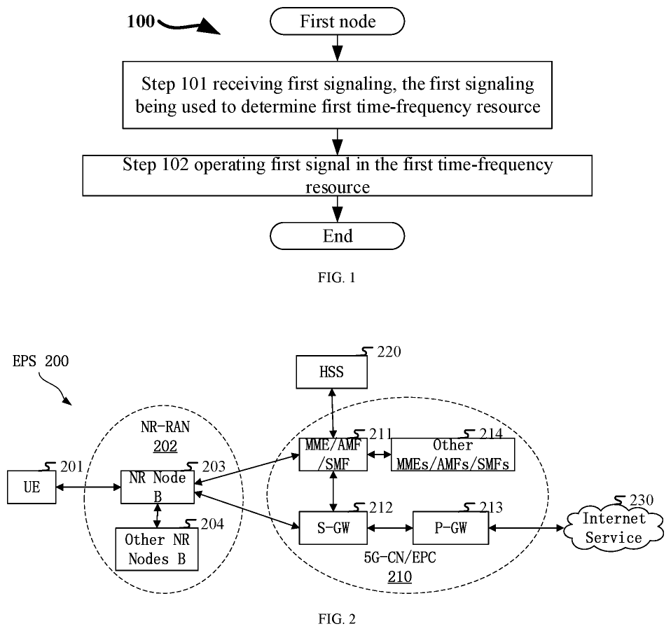

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NR-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NR-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 supports a dynamic signaling updating a QCL relation.

In one embodiment, the UE 201 supports a unified TCI configuration.

In one embodiment, the UE 201 can receive CSI-RSs from multiple TRPs at the same time.

In one embodiment, the UE 201 can receive SSBs from multiple TRPs at the same time.

In one embodiment, the UE 201 is a terminal capable of monitoring multiple beams at the same time.

In one embodiment, the UE 201 is a terminal supporting Massive-MIMO.

In one embodiment, the UE 201 supports non-dynamic scheduling.

In one embodiment, the UE 201 supports DL SPS based transmission.

In one embodiment, the UE 201 supports transmission based on uplink configured scheduling.

In one embodiment, the UE 201 supports transmission of configured scheduling on SL.

In one embodiment, the gNB 203 corresponds to the second node in the present application.

In one embodiment, the gNB 203 supports a dynamic signaling updating a QCL relation.

In one embodiment, the gNB 203 supports a unified TCI configuration.

In one embodiment, the gNB 203 can receive CSI-RSs from multiple TRPs at the same time.

In one embodiment, the gNB 203 can receive SSBs from multiple TRPs at the same time.

In one embodiment, the gNB 203 is a base station with the capability to simultaneously monitor multiple beams.

In one embodiment, the gNB 203 is a base station supporting Massive-MIMO.

In one embodiment, the gNB 203 supports non-dynamic scheduling.

In one embodiment, the gNB 203 supports DL SPS based transmission.

In one embodiment, the gNB 203 supports transmission based on uplink configured scheduling.

In one embodiment, the gNB 203 supports transmission of configured scheduling on SL.

In one embodiment, the first node in the present application corresponds to the UE 201, and the second node in the present application corresponds to the gNB 203.

### Embodiment 3

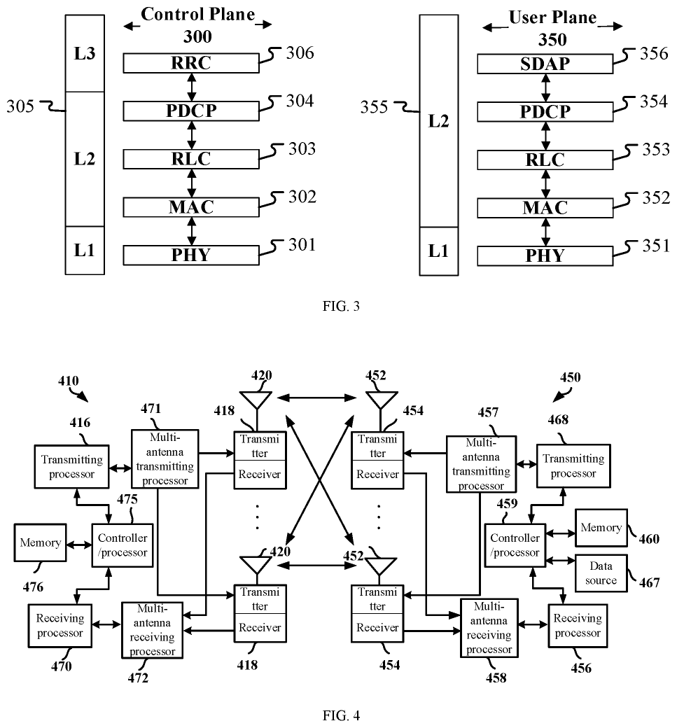

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first signaling is generated by the MAC 302 or the MAC 352.

In one embodiment, the first signaling is generated by the PHY 301 or the PHY 351.

In one embodiment, the first signal is generated by the MAC 302 or the MAC 352.

In one embodiment, the first signal is generated by the PHY 301 or the PHY 351.

In one embodiment, the first signal is generated by the RRC 306.

In one embodiment, the first information block is generated by the MAC 302 or the MAC 352.

In one embodiment, the first information block is generated by the PHY 301 or the PHY 351.

In one embodiment, the second signaling is generated by the MAC 302 or the MAC 352.

In one embodiment, the second signaling is generated by the PHY 301 or the PHY 351.

In one embodiment, the first message is generated by the MAC 302 or the MAC 352.

In one embodiment, the first message is generated by the RRC 306.

In one embodiment, the target signaling is generated by the MAC 302 or the MAC 352.

In one embodiment, the target signaling is generated by the PHY 301 or the PHY 351.

In one embodiment, the second signal is generated by the MAC 302 or the MAC 352.

In one embodiment, the second signal is generated by the PHY 301 or the PHY 351.

In one embodiment, the second signal is generated by the RRC 306.

In one embodiment, the first node is a terminal.

In one embodiment, the first node is a relay.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used to manage multiple TRPs.

In one embodiment, the second node is a node for managing multiple cells.

In one embodiment, the second node is a node for managing multiple carriers.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: first receives a first signaling, the first signaling is used to determine a first time-frequency resource; then operates a first signal in the first time-frequency resource; the first signaling is identified by a target RNTI; whether the target RNTI is used for scrambling of the first signal is related to a type of the target RNTI; the operating action is receiving, or, the operating action is transmitting; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

In one embodiment, the first communication device 450 comprises at least one processor and at least one memory, a memory that stores a computer readable instruction program. The computer readable instruction program generates an action when executed by at least one processor. The action includes: first receiving a first signaling, the first signaling being used to determine a first time-frequency resource; and then operating a first signal in the first time-frequency resource; the first signaling is identified by a target RNTI; whether the target RNTI is used for scrambling of the first signal is related to a type of the target RNTI; the operating action is receiving, or, the operating action is transmitting; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: first transmits a first signaling, the first signaling is used to determine a first time-frequency resource; and then executes a first signal in the first time-frequency resource; the first signaling is identified by a target RNTI; whether the target RNTI is used for scrambling of the first signal is related to a type of the target RNTI; the executing action is transmitting, or the executing action is receiving; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

In one embodiment, the second communication device 410 comprises a memory that stores a computer readable instruction program. The computer readable instruction program generates an action when executed by at least one processor. The action includes: first transmitting a first signaling, the first signaling being used to determine a first time-frequency resource; executing a first signal in the first time-frequency resource; the first signaling is identified by a target RNTI; whether the target RNTI is used for scrambling of the first signal is related to a type of the target RNTI; the executing action is transmitting, or the executing action is receiving; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the first communication device 450 is a relay.

In one embodiment, the second communication device 410 is a base station.

In one embodiment, the second communication device 410 is a relay.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first signaling; at least first four of the antenna 420, the transmitter 418, the multi-antenna transmitting processor 471, the transmitting processor 416 and the controller/processor 475 are used to transmit a first signaling.

In one embodiment, at least first four of the antenna 452, the receiver 454, the multi-antenna receiving processor 458, the receiving processor 456 and the controller/processor 459 are used to receive a first signal in a first time-frequency resource; at least first four of the antenna 420, the transmitter 418, the multi-antenna transmitting processor 471, the transmitting processor 416 and the controller/processor 475 are used to transmit a first signal in a first time-frequency resource.

In one embodiment, at least first four of the antenna 452, the transmitter 454, the multi-antenna transmitting processor 457, the transmitting processor 468, and the controller/processor 459 are used to transmit a first signal in a first time-frequency resource; at least first four of the antenna 420, the receiver 418, the multi-antenna receiving processor 472, the receiving processor 470 and the controller/processor 475 are used to receive a first signal in a first time-frequency resource.

In one embodiment, at least first four of the antenna 452, the receiver 454, the multi-antenna receiving processor 458, the receiving processor 456 and the controller/processor 459 are used to receive a first information block; at least first four of the antenna 420, the transmitter 418, the multi-antenna transmitting processor 471, the transmitting processor 416 and the controller/processor 475 are used to transmit a first information block.

In one embodiment, at least first four of the antenna 452, the receiver 454, the multi-antenna receiving processor 458, the receiving processor 456 and the controller/processor 459 are used to receive a second signaling; at least first four of the antenna 420, the transmitter 418, the multi-antenna transmitting processor 471, the transmitting processor 416 and the controller/processor 475 are used to transmit a second signaling.

In one embodiment, at least first four of the antenna 452, the receiver 454, the multi-antenna receiving processor 458, the receiving processor 456 and the controller/processor 459 are used to perform channel monitoring in K2 candidate time-frequency resources.

In one embodiment, at least first four of the antenna 420, the transmitter 418, the multi-antenna transmitting processor 471, the transmitting processor 416 and the controller/processor 475 are used to determine that scheduling indicated by the first signaling is deactivated or released, and determine that scheduling associated with the first signaling is dropped to be transmitted in K2 candidate time-frequency resources.

In one embodiment, at least first four of the antenna 452, the receiver 454, the multi-antenna receiving processor 458, the receiving processor 456 and the controller/processor 459 are used to receive a first message; at least first four of the antenna 420, the transmitter 418, the multi-antenna transmitting processor 471, the transmitting processor 416 and the controller/processor 475 are used to transmit a first message.

In one embodiment, at least first four of the antenna 452, the transmitter 454, the multi-antenna transmitting processor 457, the transmitting processor 468, and the controller/processor 459 are used to transmit a target signaling; at least first four of the antenna 420, the receiver 418, the multi-antenna receiving processor 472, the receiving processor 470 and the controller/processor 475 are used to receive a target signaling.

In one embodiment, at least first four of the antenna 452, the receiver 454, the multi-antenna receiving processor 458, the receiving processor 456 and the controller/processor 459 are used to receive a second signal in a second time-frequency resource; at least first four of the antenna 420, the transmitter 418, the multi-antenna transmitting processor 471, the transmitting processor 416 and the controller/processor 475 are used to transmit a second signal in a second time-frequency resource.

In one embodiment, at least first four of the antenna 452, the transmitter 454, the multi-antenna transmitting processor 457, the transmitting processor 468, and the controller/processor 459 are used to transmit a second signal in a second time-frequency resource; at least first four of the antenna 420, the receiver 418, the multi-antenna receiving processor 472, the receiving processor 470 and the controller/processor 475 are used to receive a second signal in a second time-frequency resource.

### Embodiment 5

Embodiment 5 illustrates a flowchart of a first signaling of one embodiment, as shown in FIG. 5. In FIG. 5, a first node U1 and a second node N2 are in communications via a radio link. It is particularly underlined that the order illustrated in the embodiment does not put constraints over sequences of signal transmissions and implementations. Embodiments, sub-embodiments and subsidiary embodiments of embodiment 5 can be applied to any of embodiments 6 to 11 if no conflict is caused; on the contrary, any embodiment, sub-embodiment and subsidiary embodiment of embodiments 6 to 11 can be applied to embodiment 5 without conflict.

The first node U1 receives a first signaling in step S10; receives a first information block in step S11; transmits a target signaling in step S12; in step S13, receives a first signal in a first time-frequency resource.

The second node N2 transmits a first signaling in step S20; transmits a first information block in step S21; receives a target signaling in step S22; transmits a first signal in a first time-frequency resource in step S23.

In embodiment 5, the first signaling is used to determine the first time-frequency resource; the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time; the first information block is generated at a protocol layer below the RRC layer; a CORESET where the first signaling is located is associated with a first identity; the first information block is used to determine that at least one CORESET is associated with a second identity, and the first identity is different from the second identity; the first identity and the second identity respectively identify a cell; the first time-frequency resource is located after a first effective time in time domain, scrambling of the first signal is related to a type of target RNTI, and an effective time of the first information block is the first effective time; the target signaling is used to determine that the first information block is correctly received, and a position of the first effective time in time domain is related to time-domain resources occupied by the target signaling.

In one embodiment, the first information block is transmitted through a physical-layer signaling.

In one embodiment, the first information block is transmitted through Medium Access Control (MAC) Control Elements (CEs).

In one embodiment, the first information block is transmitted through a PDCCH.

In one embodiment, the first information block is transmitted through a DCI.

In one embodiment, a CRC comprised in a PDCCH bearing the first information block is scrambled by one type of RNTI in the second type set.

In one embodiment, a CRC comprised in a PDCCH bearing the first information block is scrambled through a C-RNTI.

In one embodiment, the first information block is UE-specific.

In one embodiment, the first information block is used to indicate a first candidate time-frequency resource.

In one subembodiment of the above embodiment, the first candidate time-frequency resource comprises CSI-RS (Channel State Information Reference Signals) resources.

In one subembodiment of the above embodiment, the first candidate time-frequency resource comprises an SSB (Synchronization Signal/Physical Broadcast Channel block).

In one subembodiment of the above embodiment, the first candidate time-frequency resource comprises DMRS (Demodulation Reference Signal) resources.

In one subembodiment of the above embodiment, the first candidate time-frequency resource comprises SRS (Sounding Reference Signal) resources.

In one embodiment, the first information block is used to indicate a unified TCI.

Typically, the first information block is used to indicate a TCI.

Typically, the first information block is used to indicate a TCI-State.

Typically, the first information block is used to indicate a TCI-StateId.

Typically, the first information block is used to indicate an SRI (Sounding Reference Signal Resource Indicator).

Typically, the meaning of the above phrase that a CORESET where the first signaling is located is associated with a first identity comprises: the first signaling is located in a first CORESET, the first signaling is used to indicate a first identifier, a reference signal associated with the first identifier and a demodulation reference signal in the first CORESET are QCLed, and the reference signal associated with the first identifier is associated with the first identity.

In one embodiment, the first identifier is one of TCI, TCI-State, or TCI-StateId.

In one embodiment, the reference signal associated with the first identifier comprises at least one of a CSI-RS or an SSB.

In one embodiment, the first identifier is used to determine a reference signal resource.

In one embodiment, the meaning of the above phrase that the reference signal associated with the first identifier is associated with the first identity comprises: an RRC signaling configuring the reference signal associated with the first identifier comprises the first identity.

In one embodiment, the meaning of the above phrase that the reference signal associated with the first identifier is associated with the first identity comprises: the reference signal associated with the first identifier is transmitted by a TRP corresponding to the first identity.

In one embodiment, the meaning of the above phrase that the reference signal associated with the first identifier is associated with the first identity comprises: time-frequency resources occupied by the reference signal associated with the first identifier are maintained by a TRP corresponding to the first identity.

In one embodiment, the meaning of the above phrase that the reference signal associated with the first identifier is associated with the first identity comprises: the reference signal associated with the first identifier is scrambled through the first identity.

In one embodiment, the meaning of the above phrase that the reference signal associated with the first identifier is associated with the first identity comprises: the first identity is used to generate the reference signal associated with the first identifier.

In one embodiment, the meaning of the above phrase that the reference signal associated with the first identifier is associated with the first identity comprises: there exists an explicit signaling indicating that time-frequency resources occupied by the reference signal associated with the first identifier are associated with the first identity.

Typically, the meaning of the above phrase that the first information block is used to determine that at least one CORESET is associated with a second identity comprises: after an effective time of the first information block, there exists a second CORESET, the first information block is used to indicate a second identifier, a reference signal associated with the second identifier and a demodulation reference signal in the second CORESET are QCLed, and the reference signal associated with the second identifier is associated with the second identity.

In one embodiment, the second identifier is one of TCI, TCI-State, or TCI-StateId.

In one embodiment, the reference signal associated with the second identifier comprises at least one of a CSI-RS or an SSB.

In one embodiment, the second identifier is used to determine a reference signal resource.

In one embodiment, the meaning of the above phrase that the reference signal associated with the second identifier is associated with the second identity comprises: an RRC signaling configuring the reference signal associated with the first second comprises the second identity.

In one embodiment, the meaning of the above phrase that the reference signal associated with the second identifier is associated with the second identity comprises: the reference signal associated with the second identifier is transmitted by a TRP corresponding to the second identity.

In one embodiment, the meaning of the above phrase that the reference signal associated with the second identifier is associated with the second identity comprises: time-frequency resources occupied by the reference signal associated with the second identifier are maintained by a TRP corresponding to the second identity.

In one embodiment, the meaning of the above phrase that the reference signal associated with the second identifier is associated with the second identity comprises: the reference signal associated with the second identifier is scrambled through the second identity.

In one embodiment, the meaning of the above phrase that the reference signal associated with the second identifier is associated with the second identity comprises: the second identity is used to generate the reference signal associated with the second identifier.

In one embodiment, the meaning of the above phrase that the reference signal associated with the second identifier is associated with the second identity comprises: there exists an explicit signaling indicating that time-frequency resources occupied by the reference signal associated with the second identifier are associated with the second identity.

In one embodiment, the first CORESET and the second CORESET are a same CORESET.

In one embodiment, the first CORESET and the second CORESET are associated to a same search space.

In one embodiment, the first CORESET and the second CORESET are associated to a same search space set.

In one embodiment, at least one of the first identity and the second identity is a physical cell identifier.

In one embodiment, the first identity is a non-negative integer.

In one embodiment, the second identity is a non-negative integer.

In one embodiment, the first identity is a PCI.

In one embodiment, the second identity is a PCI.

In one embodiment, the first identity is a PCI of a serving cell.

In one embodiment, the second identity is different from a PCI of a serving cell.

In one embodiment, the second identity is a PCI other than a PCI of a serving cell.

Typically, the first information block is used to determine the first effective time.

In one embodiment, the meaning of the above the first information block being used to determine the first effective time comprises: the first node transmits a first feedback after receiving the first information block, the first feedback is an acknowledgement of the first information block, and the first effective time is Y1 symbol(s) after a last symbol occupied by the first feedback, Y1 being a positive integer.

In one subembodiment of the above embodiment, Y1 is configured by the base station.

In one subembodiment of the above embodiment, Y1 is fixed.

In one subembodiment of the above embodiment, Y1 is related to a capability of the first node.

In one embodiment, the meaning of the above the first information block being used to determine the first effective time comprises: the first information block is used to indicate the first effective time.

In one embodiment, the meaning of the above the first information block being used to determine the first effective time comprises: the first effective time is X1 symbol(s) after a last symbol occupied by the first information block, and X1 is a positive integer.

In one subembodiment of the above embodiment, X1 is configured by the base station.

In one subembodiment of the above embodiment, X1 is fixed.

In one subembodiment of the above embodiment, X1 is related to a capability of the first node.

Typically, the meaning of the above phrase that when the first time-frequency resource is located after a first effective time in time domain, scrambling of the first signal is related to a type of the target RNTI comprises: when the first time-frequency resource is located after a first effective time in time domain, and a type of the target RNTI is the first type set, the target RNTI is used for scrambling of the first signal.

Typically, the meaning of the above phrase that when the first time-frequency resource is located after a first effective time in time domain, scrambling of the first signal is related to a type of target RNTI comprises: when the first time-frequency resource is located after a first effective time in time domain, and a type of the target RNTI is the second type set, the target RNTI is not used for scrambling of the first signal.

In one embodiment, when the target RNTI is not used for scrambling of the first signal, a C-RNTI is used for scrambling of the first signal.

In one embodiment, the first effective time is Y3 symbols after a last symbol occupied by the target signaling, Y3 being a positive integer.

In one subembodiment of the above embodiment, Y3 is configured by the base station.

In one subembodiment of the above embodiment, Y3 is fixed.

In one subembodiment of the above embodiment, Y3 is related to a capability of the first node.

In one embodiment, the first effective time is Y4 slot(s) after a slot occupied by the target signaling, Y4 being a positive integer.

In one subembodiment of the above embodiment, Y4 is configured by the base station.

In one subembodiment of the above embodiment, Y4 is fixed.

In one subembodiment of the above embodiment, Y4 is related to a capability of the first node.

In one embodiment, the target signaling is used to indicate that the first information block is correctly received.

In one embodiment, a PDCCH bearing the first information block is used to schedule a given PDSCH, and the target signaling comprises a HARQ-ACK for the given PDSCH.

### Embodiment 6

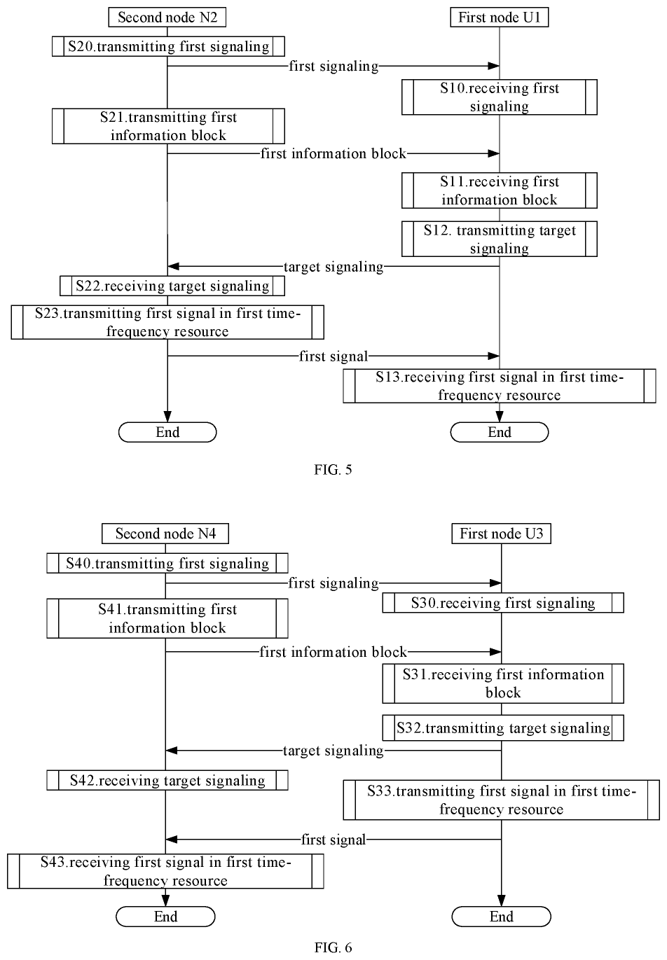

Embodiment 6 illustrates a flowchart of a first signaling of another embodiment, as shown in FIG. 6. In FIG. 6, a first node U3 and a second node N4 are in communications via a radio link. It is particularly underlined that the order illustrated in the embodiment does not put constraints over sequences of signal transmissions and implementations. Embodiments, sub-embodiments and subsidiary embodiments of embodiment 6 can be applied to any of embodiments 5 to 11 if no conflict is caused; and vice versa, any of embodiments, sub-embodiments, and subsidiary embodiments of embodiments 5 to 11 can be applied to embodiment 6 if no conflict is caused.

The first node U3 receives a first signaling in step S30; receives a first information block in step S31; transmits a target signaling in step S32; transmits a first signal in a first time-frequency resource in step S33.

The second node N4 transmits a first signaling in step S40; transmits a first information block in step S41; receives a target signaling in step S42; in step S43, receives a first signal in a first time-frequency resource.

In embodiment 6, the first signaling is used to determine the first time-frequency resource; the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time; the first information block is generated at a protocol layer below the RRC layer; a CORESET where the first signaling is located is associated with a first identity; the first information block is used to determine that at least one CORESET is associated with a second identity, and the first identity is different from the second identity; the first identity and the second identity respectively identify a cell; the first time-frequency resource is located after a first effective time in time domain, scrambling of the first signal is related to a type of target RNTI, and an effective time of the first information block is the first effective time; the target signaling is used to determine that the first information block is correctly received, and a position of the first effective time in time domain is related to time-domain resources occupied by the target signaling.

In one embodiment, a PDCCH bearing the first information block is used to schedule a given PUSCH, and the target signaling is transmitted in the given PUSCH.

In one embodiment, a PDCCH bearing the first information block is used to trigger a given PUCCH, and the target signaling is transmitted in the given PUCCH.

### Embodiment 7

Embodiment 7 illustrates a flowchart of a first message of one embodiment, as shown in FIG. 7. In FIG. 7, a first node U5 and a second node N6 are in communications via a radio link. It is particularly underlined that the order illustrated in the embodiment does not put constraints over sequences of signal transmissions and implementations. Embodiments, sub-embodiments and subsidiary embodiments of embodiment 7 can be applied to any of embodiments 5 to 11 if no conflict is incurred; and vice versa, any of embodiments, sub-embodiments, and subsidiary embodiments of embodiments 5 to 11 can be applied to embodiment 7 if no conflict is incurred.

The first node U5 receives a first message in step S50.

The second node N6 transmits a first message in step S60.

In embodiment 6, the first message is used to configure at least the target RNTI; the first message comprises a first RNTI and a second RNTI, both a type of the first RNTI and a type of the second RNTI belong to a first type set; the first RNTI and the second RNTI are respectively associated with the first identity and the second identity; the second signaling is identified by the second RNTI.

In one embodiment, the first message is an RRC signaling.

In one embodiment, the first message is UE-Specific.

Typically, a type of the first RNTI is a C-RNTI.

Typically, a type of the second RNTI is a C-RNTI.

Typically, the first RNTI is a C-RNTI.

Typically, the second RNTI is a C-RNTI.

In one embodiment, the first message is used to configure a PCI cell.

In one embodiment, the first message is used to configure a cell outside a serving cell.

In one embodiment, a name of an RRC signaling bearing the first message comprises PCI.

In one embodiment, a name of an RRC signaling bearing the first message comprises Cell.

In one embodiment, a name of an RRC signaling bearing the first message comprises Non.

In one embodiment, a name of an RRC signaling bearing the first message comprises Serving.

In one embodiment, the first RNTI and the second RNTI are different.

In one embodiment, the first RNTI is associated with a TRP maintenance of the first identity.

In one embodiment, the second RNTI is associated with a TRP maintenance of the second identity.

In one embodiment, the meaning that the second signaling is identified by a second RNTI comprises: a CRC comprised in the second signaling is scrambled through the second RNTI.

In one embodiment, the meaning that the second signaling is identified by a second RNTI comprises: the second signaling is scrambled through the second RNTI.

In one embodiment, the meaning that the second signaling is identified by a second RNTI comprises: the second signaling is generated through the second RNTI.

In one embodiment, the meaning that the second signaling is identified by a second RNTI comprises: the second RNTI is used to initialize a generator of a scrambling sequence of the second signaling.

In one embodiment, the meaning that the second signaling is identified by a second RNTI comprises: the second RNTI is used to initialize a generator of a scrambling sequence of a CRC comprised in the second signaling.

Typically, when the type of the target RNTI belongs to the first type set, the first RNTI is the target RNTI.

In one embodiment, the first RNTI is used to identify a PDCCH scheduling the first node transmitted by a TRP associated with the first identity.

In one embodiment, the second RNTI is used to identify a PDCCH scheduling the first node transmitted by a TRP associated with the second identity.

In one embodiment, a TRP associated with the first identity in the present application is a first TRP, and a TRP associated with the second identity in the present application is a second TRP.

In one subembodiment of the embodiment, the first TRP and the second TRP respectively maintain two different serving cells.

In one subembodiment of the embodiment, the first TRP and the second TRP are connected via a backhaul link.

In one subembodiment of the embodiment, the first TRP and the second TRP are maintained by a same base station.

In one embodiment, the step S50 is taken before the step S10 in Embodiment 5.

In one embodiment, the step S60 is taken before the step S20 in Embodiment 5.

In one embodiment, the step S50 is taken before the step S30 in Embodiment 6.

In one embodiment, the step S60 is taken before the step S40 in Embodiment 6.

### Embodiment 8

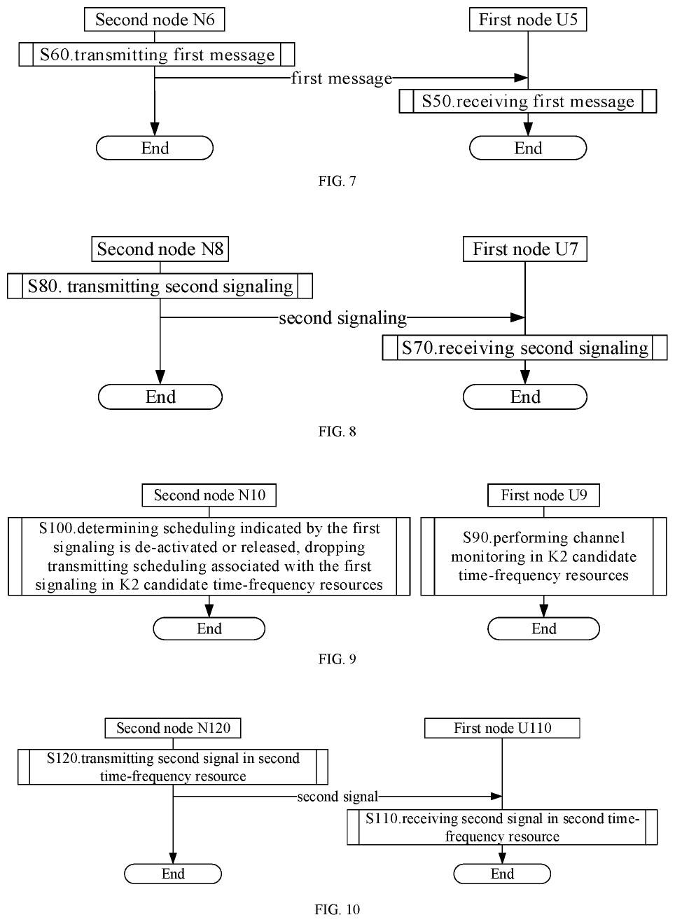

Embodiment 8 illustrates a flowchart of a second signaling of one embodiment, as shown in FIG. 8. In FIG. 8, a first node U7 and a second node N8 are in communications via a radio link. It is particularly underlined that the order illustrated in the embodiment does not put constraints over sequences of signal transmissions and implementations. Embodiments, sub-embodiments and subsidiary embodiments of embodiment 8 can be applied to any of embodiments 5 to 11 if no conflict is incurred; and vice versa, any of embodiments, sub-embodiments, and subsidiary embodiments of embodiments 5 to 11 can be applied to embodiment 8 if no conflict is caused.

The first node U7 receives a second signaling in step S70.

The second node N8 transmits a second signaling in step S80.

In embodiment 8, the type of the target RNTI belongs to the second type set; a type of RNTI used to identify the second signaling belongs to the first type set; an RNTI used to identify the second signaling is associated with the second identity; the second signaling is used to deactivate or release scheduling of the first signaling.

In one embodiment, a physical-layer channel occupied by the second signaling comprises a PDCCH.

In one embodiment, the second signaling is a DCI.

In one embodiment, the second signaling is used to de-activate scheduling of the first signaling.

In one embodiment, the second signaling is used to release scheduling of the first signaling.

In one embodiment, the second signaling is a PDCCH validation.

In one embodiment, the second signaling is used to deactivate or release an SPS.

In one embodiment, the second signaling is used to deactivate or release a CS.

In one embodiment, the second signaling is used to deactivate or release a DL SPS.

In one embodiment, the second signaling is used to deactivate or release a type 2 uplink grant.

In one embodiment, the second signaling is used to deactivate or release a type 2 configured grant scheduling on SL.

In one embodiment, the second signaling is used to deactivate or release a semi-persistent CSI.

In one embodiment, the second signaling is transmitted in the second CORESET in the present application.

In one embodiment, an RNTI used to identify the second signaling is a C-RNTI.

Typically, the second signaling is used to deactivate a downlink semi-persistent scheduling or an uplink configured scheduling indicated by the first signaling, or the second signaling is used to release a downlink semi-persistent scheduling or an uplink configured scheduling indicated by the first signaling.

Typically, the second signaling being used to release the scheduling of the first signaling is indicated through at least one field in the second signaling being set as a fixed value.

Typically, the at least one field comprises an MCS field, with a fixed value of 1 for each bit.

In one embodiment, the step S70 is taken after step S13 in Embodiment 5.

In one embodiment, the step S80 is taken after step S23 in Embodiment 5.

In one embodiment, the step S70 is taken after step S33 in Embodiment 6.

In one embodiment, the step S80 is taken after step S43 in Embodiment 6.

### Embodiment 9

Embodiment 9 illustrates a flowchart of channel monitoring of one embodiment, as shown in FIG. 9. In FIG. 9, a first node U9 and a second node N10 are in communications via a radio link. It is particularly underlined that the order illustrated in the embodiment does not put constraints over sequences of signal transmissions and implementations. Embodiments, sub-embodiments and subsidiary embodiments of embodiment 9 can be applied to any of embodiments 5 to 11 if no conflict is incurred; and vice versa, any of embodiments, sub-embodiments, and subsidiary embodiments of embodiments 5 to 11 can be applied to embodiment 9 if no conflict is incurred.

The first node U9 performs channel monitoring in K2 candidate time-frequency resources in step S90.

The second node N10 determines in step S100 that scheduling indicated by the first signaling is deactivated or released, and drops transmitting scheduling associated with the first signaling in K2 candidate time-frequency resources.

In embodiment 9, the first node receives a first signal in the first time-frequency resource, and the first signaling is used to determine K1 candidate time-frequency resources, where K1 is a positive integer greater than 1; any one of the K2 candidate time-frequency resources is one of the K1 candidate time-frequency resources; K2is a positive integer not greater than K1; and the channel monitoring performed in the K2 candidate time-frequency resources is used to determine whether scheduling indicated by the first signaling is deactivated or released.

In one embodiment, the first signaling is used to determine at least one of time-domain resources or frequency-domain resources occupied by at least one of K1 candidate time-frequency resources.

In one embodiment, the first signaling is used to determine at least one of time-domain resources or frequency-domain resources occupied by any one of K1 candidate time-frequency resources.

In one embodiment, the first signaling is used to indicate at least one of time-domain resources or frequency-domain resources occupied by at least one of K1 candidate time-frequency resources.

In one embodiment, the first signaling is used to indicate at least one of time-domain resources or frequency-domain resources occupied by any one of K1 candidate time-frequency resources.

In one embodiment, the meaning of performing channel monitoring in K2 candidate time-frequency resources comprises: respectively performing energy detections in the K2 candidate time-frequency resources.

In one subembodiment of the embodiment, a result of energy detection performed in any of the K2 candidate time-frequency resources is less than a first threshold, and scheduling indicated by the first signaling is deactivated or released.

In one subsidiary embodiment of the subembodiment, the first threshold is measured by dB.

In one subsidiary embodiment of the subembodiment, the first threshold is measured by dBm.

In one embodiment, the meaning of performing channel monitoring in K2 candidate time-frequency resources comprises: respectively performing RSRP measurements in the K2 candidate time-frequency resources.

In one subembodiment of the embodiment, a result of RSRP performed in any of the K2 candidate time-frequency resources is less than a second threshold, and scheduling indicated by the first signaling is deactivated or released.

In one subsidiary embodiment of the subembodiment, the second threshold is measured by dBm.

In one subembodiment of the embodiment, the RSRP measurement is for a DMRS in any of the K2 candidate time-frequency resources.

In one subembodiment of the embodiment, the RSRP measurement is for a CSI-RS in any of the K2 candidate time-frequency resources.

In one subembodiment of the embodiment, the RSRP measurement is for a data channel in any of the K2 candidate time-frequency resources.

In one embodiment, the meaning of performing channel monitoring in K2 candidate time-frequency resources comprises: respectively performing coherent detections in the K2 candidate time-frequency resources.

In one subembodiment of the embodiment, a result of a coherent detection performed in any of the K2 candidate time-frequency resources is used to determine that it is not correctly received in the corresponding candidate time-frequency resources, and scheduling indicated by the first signaling is deactivated or released.

In one embodiment, the meaning of performing channel monitoring in K2 candidate time-frequency resources comprises: respectively performing demodulation for a PDSCH in the K2 candidate time-frequency resources.

In one subembodiment of the embodiment, a result of a PDSCH demodulation performed on any of the K2 candidate time-frequency resources is used to determine that the PDSCH is not correctly received in the corresponding candidate time-frequency resources, and scheduling indicated by the first signaling is deactivated or released.

In one embodiment, time-domain resources occupied by any of the K2 candidate time-frequency resources are located after the first effective time.

In one embodiment, the step S90 is taken after step S13 in Embodiment 5.

In one embodiment, the step S100 is taken after step S23 in Embodiment 5.

In one embodiment, the step S90 is taken after step S33 in Embodiment 6.

In one embodiment, the step S100 is taken after step S43 in Embodiment 6.

### Embodiment 10

Embodiment 10 illustrates a flowchart of a second signal, as shown in FIG. 10. In FIG. 110, a first node U11 and a second node N12 are in communications via a radio link. It is particularly underlined that the order illustrated in the embodiment does not put constraints over sequences of signal transmissions and implementations. Embodiments, sub-embodiments and subsidiary embodiments of embodiment 10 can be applied to any of embodiments 5 to 11 if no conflict is incurred; and vice versa, any of embodiments, sub-embodiments, and subsidiary embodiments of embodiments 5 to 11 can be applied to embodiment 10 if no conflict is incurred.

The first node U11 receives a second signal in a second time-frequency resource in step S110.

The second node N12 transmits a second signal in a second time-frequency resource in step S120.

In embodiment 10, the first signaling is used to determine multiple candidate time-frequency resources, the second time-frequency resource is one of the multiple candidate time-frequency resources, and the second time-frequency resource is different from the first time-frequency resource; the second time-frequency resource is located before the first effective time in time domain, and the first time-frequency resource is located after the first effective time in time domain; a first candidate time-frequency resource is used to determine spatial characteristics of the first signal, and a second candidate time-frequency resource is used to determine spatial characteristics of the second signal; the first candidate time-frequency resource is different from the second candidate time-frequency resource; the first information block is used to determine the first candidate time-frequency resource.

In one embodiment, the first node receives the second signal in the second time-frequency resource, and the first node receives the first signal in the first time-frequency resource.

In one embodiment, the second node transmits the second signal in the second time-frequency resource, and the second node transmits the first signal in the first time-frequency resource.

In one embodiment, the first signaling is used to determine the second candidate time-frequency resource.

In one embodiment, the first signaling is used to indicate the second candidate time-frequency resources.

In one embodiment, the first information block is used to indicate the first candidate time-frequency resource.

In one embodiment, the second time-frequency resource set occupies more than one positive integer number of REs.

In one embodiment, the first signaling is used to indicate the second candidate time-frequency resources.

In one embodiment, the second candidate time-frequency resource comprises CSI-RS resources.

In one embodiment, the second candidate time-frequency resource comprises an SSB.

In one embodiment, the second candidate time-frequency resource comprises DMRS resources.

In one embodiment, the second candidate time-frequency resource comprises SRS resources.

In one embodiment, a physical-layer channel occupied by the second signal comprises a PDSCH.

In one embodiment, a transport channel occupied by the second signal comprises a DL-SCH.

Typically, the first signaling is used to indicate a TCI, and the second candidate time-frequency resource is associated with the TCI.

Typically, the first signaling is used to indicate a TCI-State, and the second candidate time-frequency resource is associated with the TCI-State.

Typically, the first signaling is used to indicate a TCI-StateId, and the second candidate time-frequency resource is associated with the TCI-StateId.

Typically, the first signaling is used to indicate an SRI, and the second candidate time-frequency resource is associated with the SRI.

Typically, the meaning of the above phrase that the first candidate time-frequency resource is used to determine spatial characteristics of the first signal comprises: a demodulation reference signal used for demodulating the first signal and a radio signal transmitted in the first candidate time-frequency resource are QCLed.

Typically, the meaning of the above phrase that the first candidate time-frequency resource is used to determine spatial characteristics of the first signal comprises: a demodulation reference signal used for demodulating the first signal and a radio signal transmitted in the first candidate time-frequency resource adopt same QCL parameters.

Typically, the meaning of the above phrase that the first candidate time-frequency resource is used to determine spatial characteristics of the first signal comprises: a demodulation reference signal used for demodulating the first signal and the first candidate time-frequency resource are QCLed.

Typically, the meaning of the above phrase that the first candidate time-frequency resource is used to determine spatial characteristics of the first signal comprises: a demodulation reference signal used for demodulating the first signal and the first candidate time-frequency resource adopt same QCL parameters.

Typically, the meaning of the above phrase that a first candidate time-frequency resource is used to determine spatial characteristics of the first signal comprises: a demodulation reference signal used for demodulating the first signal and the first candidate time-frequency resource are QCLed.

Typically, the meaning of the above phrase that the first candidate time-frequency resource is used to determine spatial characteristics of the first signal comprises: a demodulation reference signal used for demodulating the first signal and the first candidate time-frequency resource adopt same QCL parameters.

Typically, the meaning of the above phrase that the first candidate time-frequency resource is used to determine spatial characteristics of the first signal comprises: a radio signal transmitted in the first candidate time-frequency resource adopts same spatial reception parameters as the first signal.

Typically, the meaning of the above phrase that the first candidate time-frequency resource is used to determine spatial characteristics of the first signal comprises: a radio signal transmitted from the first candidate time-frequency resource is used to determine spatial Tx parameters of the first signal.

Typically, the meaning of the above phrase that the first candidate time-frequency resource is used to determine spatial characteristics of the first signal comprises: a radio signal transmitted in the first candidate time-frequency resource and the first signal adopt a same spatial relation.

Typically, the meaning of the above phrase that the first candidate time-frequency resource is used to determine spatial characteristics of the first signal comprises: the first node is able to infer from large scale characteristics of a channel to which a radio signal being transmitted in the first candidate time-frequency resource is conveyed large scale characteristics of a channel to which the first signal is conveyed.

In one embodiment, the spatial characteristics comprise QCL parameters.

In one embodiment, the spatial characteristics comprises Spatial Rx parameters.

In one embodiment, the spatial characteristics comprises spatial reception filtering.

In one embodiment, the spatial characteristics comprises Spatial Tx parameters.

In one embodiment, the spatial characteristics comprise Spatial Domain Transmission Filter.

In one embodiment, the spatial characteristics comprise spatial relation.

In one embodiment, the spatial characteristics comprise a precoder.

In one embodiment, a type of QCL in the present application comprises QCL-TypeA.

In one embodiment, a type of QCL in the present application comprises QCL-TypeB.

In one embodiment, a type of QCL in the present application comprises QCL-TypeC.

In one embodiment, a type of QCL in the present application comprises QCL-TypeD.

In one embodiment, the QCL TypeA comprises Doppler shift, Doppler spread, average delay, and delay spread.

In one embodiment, the QCL TypeB comprises Doppler shift and Doppler spread.

In one embodiment, the QCL TypeC comprises Doppler shift and average delay.

In one embodiment, the QCL-TypeD comprises a Spatial Rx parameter.

In one embodiment, the large-scale characteristics comprise one or more of delay spread, Doppler spread, Doppler shift, average delay, or spatial Rx parameter.

In one embodiment, the step S110 is taken after the step S10 and before the step S11 in embodiment 5.

In one embodiment, the step S120 is taken after the step S20 and before the step S21 in embodiment 5.

### Embodiment 11

Embodiment 11 illustrates a flowchart of a second signal of another embodiment, as shown in FIG. 11. In FIG. 11, a first node U13 and a second node N14 are in communications via a radio link. It is particularly underlined that the order illustrated in the embodiment does not put constraints over sequences of signal transmissions and implementations. Embodiments, sub-embodiments and subsidiary embodiments of embodiment 11 can be applied to any of embodiments 5 to 10 if no conflict is incurred; and vice versa, any of embodiments, sub-embodiments, and subsidiary embodiments of embodiments 5 to 10 can be applied to embodiment 11 if no conflict is incurred.

The first node U13 transmits a second signal in a second time-frequency resource in step S130.

The second node N14 receives a second signal in a second time-frequency resource in step S140.

In embodiment 11, the first signaling is used to determine multiple candidate time-frequency resources, the second time-frequency resource is one of the multiple candidate time-frequency resources, and the second time-frequency resource is different from the first time-frequency resource; the second time-frequency resource is located before the first effective time in time domain, and the first time-frequency resource is located after the first effective time in time domain; a first candidate time-frequency resource is used to determine spatial characteristics of the first signal, and a second candidate time-frequency resource is used to determine spatial characteristics of the second signal; the first candidate time-frequency resource is different from the second candidate time-frequency resource; the first information block is used to determine the first candidate time-frequency resource.

In one embodiment, the first node transmits the second signal in the second time-frequency resource, and the first node transmits the first signal in the first time-frequency resource.

In one embodiment, the second node receives the second signal in the second time-frequency resource, and the second node receives the first signal in the first time-frequency resource.

In one embodiment, the second candidate time-frequency resource comprises SRS resources.

In one embodiment, a physical-layer channel occupied by the second signal comprises a PUSCH.

In one embodiment, a transport channel occupied by the second signal comprises a UL-SCH.

In one embodiment, the step S130 is taken after the step S30 and before the step S31 in embodiment 6.

In one embodiment, the step S140 is taken after the step S40 and before the step S41 in embodiment 6.

### Embodiment 12

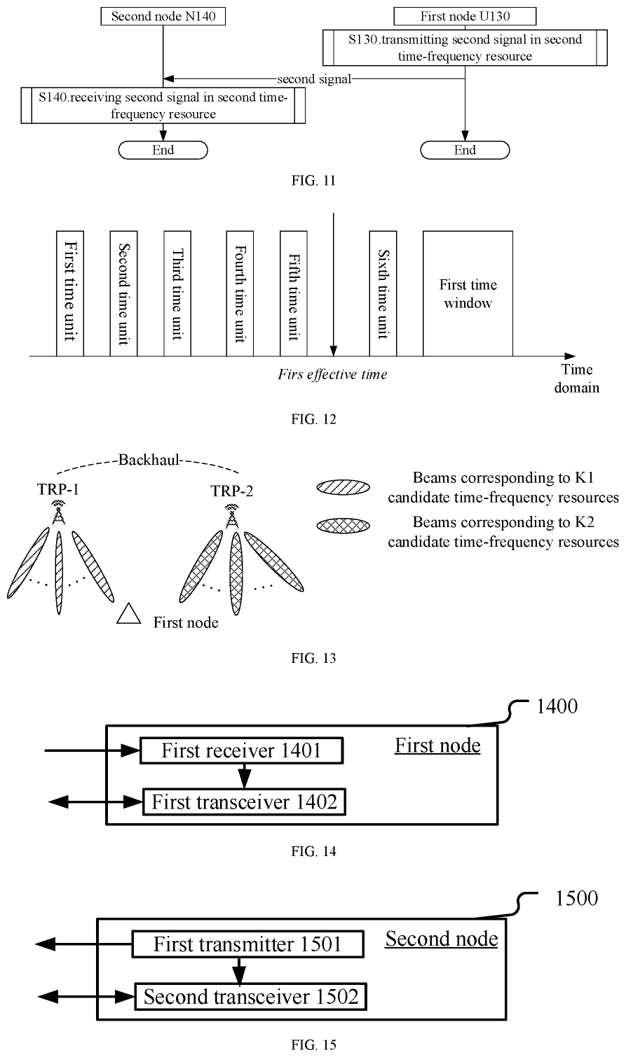

Embodiment 12 illustrates a schematic diagram of a timing relation of one embodiment, as shown in FIG. 12. In FIG. 12, time-domain resources occupied by the first message of the present application are located in a first time unit, time-domain resources occupied by a first signaling of the present application are located in a second time unit, time-domain resources occupied by a second signal of the present application are located in a third time unit, time-domain resources occupied by a first information block of the present application are located in a fourth time unit, time-domain resources occupied by a target signaling of the present application are located in a fifth time unit, time-domain resources occupied by a first signal of the present application are located in a sixth time unit, and time-domain resources occupied by a second signaling of the present application or time-domain resources occupied by any of the K2 candidate time frequency resources of the present application are located in a first time window; the first time unit, the second time unit, the third time unit, the fourth time unit, the fifth time unit, the sixth time unit, and the first time window are chronologically and sequentially sorted in an ascending order in time domain; the arrow in the figure corresponds to a first effective time in the present application.

In one embodiment, a given time unit is one of a slot, a sub-slot, or a mini-slot.

In one embodiment, a given time unit comprises a positive integer of OFDM symbol(s).

In one subembodiment of the above two embodiments, the given time unit is the first time unit.

In one subembodiment of the above two embodiments, the given time unit is the second time unit.

In one subembodiment of the above two embodiments, the given time unit is the third time unit.

In one subembodiment of the above two embodiments, the given time unit is the fourth time unit.

In one subembodiment of the above two embodiments, the given time unit is the fifth time unit.

In one subembodiment of the above two embodiments, the given time unit is the sixth time unit.

In one embodiment, the first time window comprises more than one positive integer number of continuous slots.

In one embodiment, the first time window only comprises one slot.

### Embodiment 13

Embodiment 13 illustrates a schematic diagram of an application scenario of one embodiment, as shown in FIG. 13. In FIG. 13, both TRP-1 and TRP-2 shown in the figure are managed by the second node in the present application; alternatively, TRP-1 as shown is managed by the second node in the present application and TRP-2 is managed by an adjacent base station of the second node; the first identity in the present application is associated with the TRP-1, and the second identity in the present application is associated with the TRP-2; the first node moves within the coverage ranges of the TRP-1 and the TRP-2.

The TRP-1 shown in the figure maintains a first candidate time-frequency resource set, and the first candidate time-frequency resource set comprises K1 candidate time-frequency resources; the TRP-2 shown in the figure maintains a second candidate time-frequency resource set, and the second candidate time-frequency resource set comprises K2 candidate time-frequency resources; both K1 and K2 are positive integers greater than 1.

In one embodiment, the K1 candidate time-frequency resources respectively correspond to K1 TCI-StateIds.

In one embodiment, the K1 candidate time-frequency resources are all associated with the first identity.

In one embodiment, the K2 candidate time-frequency resources respectively correspond to K2 TCI-StateIds.

In one embodiment, the K2 candidate time-frequency resources are all associated with the second identity.

In one embodiment, there exists a backhaul link between the TRP-1 and the TRP-2.

In one embodiment, the second candidate time-frequency resource indicated by the first signaling is one of the K1 candidate time-frequency resources.

In one embodiment, the first candidate time-frequency resource indicated by the first information block is one of the K2 candidate time-frequency resources.

### Embodiment 14

Embodiment 14 illustrates a structure block diagram in a first node, as shown in FIG. 14. In FIG. 14, the first node 1400 comprises a first receiver 1401 and a first transceiver 1402.

The first receiver 1401 receives a first signaling, the first signaling is used to determine a first time-frequency resource; and
the first transceiver 1402 receives a first signal in the first time-frequency resource, or transmits a first signal in the first time-frequency resource;

In embodiment 14, the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

In one embodiment, the first transceiver 1402 receives a first information block, the first information block is generated at a protocol layer below the RRC layer; a CORESET where the first signaling is located is associated with a first identity; the first information block is used to determine that at least one CORESET is associated with a second identity, and the first identity is different from the second identity; the first identity and the second identity respectively identify a cell; only when the first time-frequency resource is located after a first effective time in time domain, scrambling of the first signal is related to a type of target RNTI, and an effective time of the first information block is the first effective time.

In one embodiment, the first transceiver 1402 receives a second signaling; the type of the target RNTI belongs to the second type set; a type of RNTI used to identify the second signaling belongs to the first type set; an RNTI used to identify the second signaling is associated with the second identity; the second signaling is used to deactivate or release scheduling of the first signaling.

In one embodiment, the first transceiver 1402 performs channel monitoring in K2 candidate time-frequency resources; the first transceiver 1402 receives a first signal in the first time-frequency resource; the first signaling is used to determine K1 candidate time-frequency resources, where K1 is a positive integer greater than 1; any one of the K2 candidate time-frequency resources is one of the K1 candidate time-frequency resources; K2 is a positive integer not greater than K1; and the channel monitoring performed in the K2 candidate time-frequency resources is used to determine whether scheduling indicated by the first signaling is deactivated or released.

In one embodiment, the first receiver 1401 receives a first message; the first message is used to configure at least the target RNTI; the first message comprises a first RNTI and a second RNTI, both a type of the first RNTI and a type of the second RNTI belong to a first type set; the first RNTI and the second RNTI are respectively associated with the first identity and the second identity; the second signaling is identified by the second RNTI.

In one embodiment, the first transceiver 1402 transmits a target signaling; the target signaling is used to determine that the first information block is correctly received, and a position of the first effective time in time domain is related to time-domain resources occupied by the target signaling.

In one embodiment, the first transceiver 1402 receives a second signal in a second time-frequency resource, or the first transceiver 1402 transmits a second signal in a second time-frequency resource; the first signaling is used to determine multiple candidate time-frequency resources, the second time-frequency resource is one of the multiple candidate time-frequency resources, and the second time-frequency resource is different from the first time-frequency resource; the second time-frequency resource is located before the first effective time in time domain, and the first time-frequency resource is located after the first effective time in time domain; a first candidate time-frequency resource is used to determine spatial characteristics of the first signal, and a second candidate time-frequency resource is used to determine spatial characteristics of the second signal; the first candidate time-frequency resource is different from the second candidate time-frequency resource; the first information block is used to determine the first candidate time-frequency resource.

In one embodiment, the first receiver 1401 comprises at least first four of the antenna 452, the receiver 454, the multi-antenna receiving processor 458, the receiving processor 456 and the controller/processor 459 in Embodiment 4.

In one embodiment, the first transceiver 1402 comprises at least first six of the antenna 452, the receiver/transmitter 454, the multi-antenna transmitter 457, the transmitting processor 468, the multi-antenna receiving processor 458, the receiving processor 456 and the controller/processor 459 in Embodiment 4.

In one embodiment, the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time; the first type set comprises a C-RNTI, and the second type set does not comprise a C-RNTI; the second type set comprises at least one of a CS-RNTI, an SPS-RNTI, or an SP-CSI-RNTI; a physical-layer channel occupied by the first signaling comprises a PDCCH, and a physical-layer channel occupied by the first signal comprises at least one of a PDSCH, a PUSCH, or a PUCCH.

### Embodiment 15

Embodiment 15 illustrates a structure block diagram of a second node, as shown in FIG. 15. In FIG. 15, the second node 1500 comprises a first transmitter 1501 and a second transceiver 1502.

The first transmitter 1501 transmits a first signaling, the first signaling is used to determine a first time-frequency resource; and
the second transceiver 1502 transmits a first signal in the first time-frequency resource, or receives a first signal in the first time-frequency resource;

In embodiment 15, the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

In one embodiment, the second transceiver 1502 transmits a first information block, the first information block is generated at a protocol layer below the RRC layer; a CORESET where the first signaling is located is associated with a first identity; the first information block is used to determine that at least one CORESET is associated with a second identity, and the first identity is different from the second identity; the first identity and the second identity respectively identify a cell; only when the first time-frequency resource is located after a first effective time in time domain, scrambling of the first signal is related to a type of target RNTI, and an effective time of the first information block is the first effective time.

In one embodiment, the second transceiver 1502 transmits a second signaling; the type of the target RNTI belongs to the second type set; a type of RNTI used to identify the second signaling belongs to the first type set; an RNTI used to identify the second signaling is associated with the second identity; the second signaling is used to deactivate or release scheduling of the first signaling.

In one embodiment, the second transceiver 1502 determines whether scheduling indicated by the first signaling is deactivated or released, and drops transmitting scheduling associated with the first signaling in K2candidate time-frequency resources; the second transceiver 1502 transmits a first signal in the first time-frequency resource; the first signaling is used to determine K1 candidate time-frequency resources, where K1 is a positive integer greater than 1; any one of the K2 candidate time-frequency resources is one of the K1 candidate time-frequency resources; K2 is a positive integer not greater than K1; a receiver of the first signaling comprises a first node, and the channel monitoring performed by the first node in the K2 candidate time-frequency resources is used to determine whether scheduling indicated by the first signaling is deactivated or released.

In one embodiment, the first transmitter 1501 transmits a first message; the first message is used to configure at least the target RNTI; the first message comprises a first RNTI and a second RNTI, both a type of the first RNTI and a type of the second RNTI belong to a first type set; the first RNTI and the second RNTI are respectively associated with the first identity and the second identity; the second signaling is identified by the second RNTI.

In one embodiment, the second transceiver 1502 receives a target signaling; the target signaling is used to determine that the first information block is correctly received by a transmitter of the target signaling, and a position of the first effective time in time domain is related to time-domain resources occupied by the target signaling.

In one embodiment, the second transceiver 1502 transmits a second signal in a second time-frequency resource, or the second transceiver 1502 receives a second signal in a second time-frequency resource; the first signaling is used to determine multiple candidate time-frequency resources, the second time-frequency resource is one of the multiple candidate time-frequency resources, and the second time-frequency resource is different from the first time-frequency resource; the second time-frequency resource is located before the first effective time in time domain, and the first time-frequency resource is located after the first effective time in time domain; a first candidate time-frequency resource is used to determine spatial characteristics of the first signal, and a second candidate time-frequency resource is used to determine spatial characteristics of the second signal; the first candidate time-frequency resource is different from the second candidate time-frequency resource; the first information block is used to determine the first candidate time-frequency resource.

In one embodiment, the first transmitter 1501 comprises at least first four of the antenna 420, the transmitter 418, the multi-antenna transmitting processor 471, the transmitting processor 414 and the controller/processor 475 in embodiment 4.

In one embodiment, the second transceiver 1502 comprises at least first six of the antenna 420, the transmitter/receiver 418, the multi-antenna transmitting processor 471, the multi-antenna receiving processor 472, the transmitting processor 416, the receiving processor 470, and the controller/processor 475 in embodiment 4.

In one embodiment, the first signaling is identified by a target RNTI; whether the target RNTI is used for scrambling of the first signal is related to a type of the target RNTI; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time; the first type set comprises a C-RNTI, and the second type set does not comprise a C-RNTI; the second type set comprises at least one of a CS-RNTI, an SPS-RNTI, or an SP-CSI-RNTI; a physical-layer channel occupied by the first signaling comprises a PDCCH, and a physical-layer channel occupied by the first signal comprises at least one of a PDSCH, a PUSCH, or a PUCCH.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, cars, RSUs, aircrafts, diminutive airplanes, unmanned aerial vehicles, telecontrolled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being used to determine a first time-frequency resource; and
a first transceiver, operating a first signal in the first time-frequency resource;
wherein the first signaling is identified by a target RNTI; whether the target RNTI is used for scrambling of the first signal is related to a type of the target RNTI; the operating action is receiving, or, the operating action is transmitting; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

2. The first node according to claim 1, comprising:
the first transceiver, receiving a first information block, the first information block being generated at a protocol layer below the RRC layer;
wherein a CORESET where the first signaling is located is associated with a first identity; the first information block is used to determine that at least one CORESET is associated with a second identity, and the first identity is different from the second identity; the first identity and the second identity respectively identify a cell; only when the first time-frequency resource is located after a first effective time in time domain, scrambling of the first signal is related to a type of target RNTI, and an effective time of the first information block is the first effective time.

3. The first node according to claim 2, comprising:
the first transceiver, receiving a second signaling;
wherein the type of the target RNTI belongs to the second type set; a type of RNTI used to identify the second signaling belongs to the first type set; an RNTI used to identify the second signaling is associated with the second identity; the second signaling is used to deactivate or release scheduling of the first signaling.

4. The first node according to claim 2, comprising:
the first transceiver, performing channel monitoring in K2 candidate time-frequency resources;
wherein the operating action is receiving, the first signaling being used to determine K1 candidate time-frequency resources, where K1 is a positive integer greater than 1; any one of the K2 candidate time-frequency resources is one of the K1 candidate time-frequency resources; K2 is a positive integer not greater than K1; and the channel monitoring performed in the K2 candidate time-frequency resources is used to determine whether scheduling indicated by the first signaling is deactivated or released.

5. The first node according to claim 3, comprising:
the first receiver, receiving a first message;
wherein the first message is used to configure at least the target RNTI; the first message comprises a first RNTI and a second RNTI, both a type of the first RNTI and a type of the second RNTI belong to a first type set; the first RNTI and the second RNTI are respectively associated with the first identity and the second identity; the second signaling is identified by the second RNTI.

6. The first node according to claim 2, comprising:
the first transceiver, transmitting a target signaling;
wherein the target signaling is used to determine that the first information block is correctly received, and a position of the first effective time in time domain is related to time-domain resources occupied by the target signaling.

7. The first node according to claim 2, comprising:
the first transceiver, operating a second signal in a second time-frequency resource;
wherein the operating action is receiving, or, the operating action is transmitting; the first signaling is used to determine multiple candidate time-frequency resources, the second time-frequency resource is one of the multiple candidate time-frequency resources, and the second time-frequency resource is different from the first time-frequency resource; the second time-frequency resource is located before the first effective time in time domain, and the first time-frequency resource is located after the first effective time in time domain; a first candidate time-frequency resource is used to determine spatial characteristics of the first signal, and a second candidate time-frequency resource is used to determine spatial characteristics of the second signal; the first candidate time-frequency resource is different from the second candidate time-frequency resource; the first information block is used to determine the first candidate time-frequency resource.

8. The first node according to claim 1, wherein the first type set comprises a C-RNTI, and the first type set does not comprise any of a CS-RNTI, an SPS-RNTI, or an SP-CSI-RNTI.

9. The first node according to claim 1, wherein the second type set does not comprise a C-RNTI, and the second type set comprises at least a CS-RNTI.

10. The first node according to claim 2, wherein the first information block is used to indicate a TCI.

11. The first node according to claim 2, wherein the first identity is a PCI of a serving cell, and the second identity is a PCI other than a PCI of a serving cell.

12. A second node for wireless communications, comprising:
a first transmitter, transmitting a first signaling, the first signaling being used to determine a first time-frequency resource; and
a second transceiver, executing a first signal in the first time-frequency resource;
wherein the first signaling is identified by a target RNTI; whether the target RNTI is used for scrambling of the first signal is related to a type of the target RNTI; the executing action is transmitting, or the executing action is receiving; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

13. The second node according to claim 12, comprising:
the second transceiver, transmitting a first information block, the first information block being generated at a protocol layer below the RRC layer;
wherein a CORESET where the first signaling is located is associated with a first identity; the first information block is used to determine that at least one CORESET is associated with a second identity, and the first identity is different from the second identity; the first identity and the second identity respectively identify a cell; only when the first time-frequency resource is located after a first effective time in time domain, scrambling of the first signal is related to a type of target RNTI, and an effective time of the first information block is the first effective time.

14. The second node according to claim 13, comprising:
the second transceiver, transmitting a second signaling;
wherein the type of the target RNTI belongs to the second type set; a type of RNTI used to identify the second signaling belongs to the first type set; an RNTI used to identify the second signaling is associated with the second identity; the second signaling is used to deactivate or release scheduling of the first signaling.

15. The second node according to claim 13, comprising:
the second transceiver, determining whether scheduling indicated by the first signaling is deactivated or released, and dropping transmitting scheduling associated with the first signaling in K2 candidate time-frequency resources;
wherein the executing action is transmitting, the first signaling is used to determine K1 candidate time-frequency resources, where K1 is a positive integer greater than 1; any one of the K2 candidate time-frequency resources is one of the K1 candidate time-frequency resources; K2 is a positive integer not greater than K1; a receiver of the first signaling comprises a first node, and the channel monitoring performed by the first node in the K2 candidate time-frequency resources is used to determine whether scheduling indicated by the first signaling is deactivated or released.

16. The second node according to claim 14, comprising:
the first transmitter, transmitting a first message;
wherein the first message is used to configure at least the target RNTI; the first message comprises a first RNTI and a second RNTI, both a type of the first RNTI and a type of the second RNTI belong to a first type set; the first RNTI and the second RNTI are respectively associated with the first identity and the second identity; the second signaling is identified by the second RNTI.

17. The second node according to claim 13, comprising:
the second transceiver, receiving a target signaling;
wherein the target signaling is used to determine that the first information block is correctly received, and a position of the first effective time in time domain is related to time-domain resources occupied by the target signaling.

18. The second node according to claim 13, comprising:
the second transceiver, executing a second signal in a second time-frequency resource;
wherein the executing action is transmitting, or the executing action is receiving; the first signaling is used to determine multiple candidate time-frequency resources, the second time-frequency resource is one of the multiple candidate time-frequency resources, and the second time-frequency resource is different from the first time-frequency resource; the second time-frequency resource is located before the first effective time in time domain, and the first time-frequency resource is located after the first effective time in time domain; a first candidate time-frequency resource is used to determine spatial characteristics of the first signal, and a second candidate time-frequency resource is used to determine spatial characteristics of the second signal; the first candidate time-frequency resource is different from the second candidate time-frequency resource; the first information block is used to determine the first candidate time-frequency resource.

19. A method in a first node for wireless communications, comprising:
receiving a first signaling, the first signaling being used to determine a first time-frequency resource; and
operating a first signal in the first time-frequency resource;
wherein the first signaling is identified by a target RNTI; whether the target RNTI is used for scrambling of the first signal is related to a type of the target RNTI; the operating action is receiving, or, the operating action is transmitting; the type of the target RNTI belongs to one of a first type set and a second type set; when the type of the target RNTI belongs to the first type set, the target RNTI is used for scrambling of the first signal, and when the type of the target RNTI belongs to the second type set, the target RNTI is not used for scrambling of the first signal; only the first type set in the first type set and the second type set comprises a C-RNTI; there does not exist an RNTI type belonging to the first type set and the second type set at the same time.

20. The method in a first node according to claim 19, comprising:
receiving a first information block, the first information block being generated at a protocol layer below the RRC layer;
wherein a CORESET where the first signaling is located is associated with a first identity; the first information block is used to determine that at least one CORESET is associated with a second identity, and the first identity is different from the second identity; the first identity and the second identity respectively identify a cell; only when the first time-frequency resource is located after a first effective time in time domain, scrambling of the first signal is related to a type of target RNTI, and an effective time of the first information block is the first effective time.
